(19) United States
(12) Patent Application Publication
(10) Pub. No.: US 2007/0062935 A1
(43) Pub. Date: Mar. 22, 2007

(54) A microwave heating system for conditioning air in a space by heating the air to change its temperature

(75) Inventors: Matthew Aaron Dawson, cambridge, MA (US); Jonathan Kirk Dawson, Aurora, CO (US)

Correspondence Address: MATTHEW A. DAWSON, P.O. BOX 5278, ENGLEWOOD, CO, 80155, US

(73) Assignee: Matthew Aaron Dawson, Cambridge, MA (US)

(21) Appl. No.: 11/162,007

(22) Filed: Aug. 25, 2005

(51) Int. Cl. H05B 6/64

(52) U.S. Cl. 219/681

(57) ABSTRACT

A microwave heating system is provided which heats air for a heated space in a heater. The heater includes two concentric enclosures which form an inner and an outer enclosure. The enclosures have an upper end and a lower end. A heating substrate is located in the inner enclosure. The heating substrate is mounted inside the enclosure. One magnetron for generating microwaves is mounted adjacent to the heating substrate in the outer enclosure. The magnetron is for directing microwaves into the heating substrate. An electrical distribution system is connected to the magnetron. Air is drawn from inside the heated space and is directed to the heater through an intake channel. The intake channel is in air communication with the inner enclosure and the outer enclosure. The air flows into the inner enclosure where the temperature of the air changes. The inner enclosure and the outer enclosure are in air communication with a return channel. The air then flows back to the heated space through a return channel. An air circulator is located within the return channel.

### SUMMARY OF THE INVENTION

In accordance with a preferred embodiment of the present invention, a heating system is provided which heats air using energy in the form of microwaves. Air flows through an inlet channel into the inner enclosure of the heater. The heater includes an inner enclosure and an outer enclosure which forms an enclosure. The enclosure has an upper end and a lower end. A magnetron, which generates microwaves is located on the interior of the outer enclosure. The magnetron produces microwaves, directing them into a solid substrate located inside the inner enclosure. The solid substrate increases in temperature as a result of coupling with microwaves produced by the magnetron. Air is heated in the interior of the inner enclosure by convection and radiation heat transfer off of the solid substrate. Heated air flows out of the inner enclosure into a return channel. A circulation pump to move the air is located in the return channel. An electrical distribution system is connected to the magnetron.

The heating system heats air using electricity as the source of energy, avoiding the direct combustion of fossil fuels and eliminating the production of harmful pollutants indoors. Further, the heating system does not require constant air exchange with the outdoors, resulting in a more energy efficient heating system. Moreover the heating system utilizes the unique coupling properties of the substrate, described herein, with microwaves to produce substantial amounts of heat with minimal amounts of electricity, resulting in a significant reduction in the cost of space heating. In addition, the heating system heats air through convective forced air heating, which is efficient and effective.

### DETAILED DESCRIPTION OF THE INVENTION

As shown in FIG. 1, heating apparatus 01, according to the invention comprises outer hull 20 which may be made as a rectangular form or cylindrical form. Outer hull 20 is divided into two portions including the magnetron chamber 02 and the heat exchange chamber 03. The partition of these two chambers is made by partition wall 04 at the predetermined position.

Magnetron chamber 02 is provided with the magnetron assembly 111 and cooling fan 12 installed therein. Magnetron assembly 11 is electrically connected to power distribution assembly 23. Magnetron assembly 11 introduces microwaves into heat exchange chamber 03. Cooling fan 12 is mounted adjacent to the magnetron assembly 11 and connected to the power distribution assembly 23 to cool the heat generated by the magnetron assembly 11. Cooling fan intake 13 formed on the surface of magnetron chamber 02 directs cooling air from outside the outer hull 20 into magnetron chamber 02. Cooling fan exhaust 14 directs cooling air from inside magnetron chamber 02 to outside of outer hull 20.

Heat exchange chamber 03 is enclosed by inner hull 19 and provided with the solid substrate members 21 located in the predetermined positions. Inner hull 19 is comprised of microwave reflective material designed to operate in high temperatures environments. Solid substrate members 21 act to absorb the microwaves emitted by magnetron assembly 111 and heat by themselves. Solid substrate members 21 are detailed in FIG. 2.

Heated air intake channel 16 is formed on the surface of the heat exchange chamber 03 comprising microwave shielding 18 which prevents microwaves from leaking out of heat exchange chamber 03 and allows air intake from outside of the outer hull 20. Heated air return channel 17 is formed on the surface of heat exchange chamber 03 comprising microwave shielding 18 which prevents microwaves from leaking out of heat exchange chamber 03 and allows heated air to be discharged from the outer hull 20. Microwave shielding 18 is provided with numerous ventilation holes pierced at an equivalent space staggered against the air blowing direction so as to reflect/block the microwaves, in which ventilation holes have an inner diameter formed at the appropriate rate according to the impedance relationship of the microwaves to prevent leakage of the microwaves. Blowing fan 15 in air communication with the heated air intake channel and the inner hull 19 is located adjacent to inner hull 19. Blowing fan 15 drives air from outside the outer hull 20 into the inner hull 19 through the heated air intake channel 16. The air introduced by blowing fan 15 into the heat exchange chamber 03 is heated through convection with the solid substrate members 21. The heat exchanged air is then forcedly discharged through the heated air return channel 17 comprising microwave shielding 18 to obtain the warming effect on the indoors. Muffling filters 26 attach to the interior heated air intake channel and heated air return channel to control noise, vibration, and pollution and improve reliability and performance of the heating apparatus system 01.

Temperature monitoring assembly 24 attached to the surface of magnetron assembly 111 and the predetermined solid substrate members 21 is electrically connected to the power distribution assembly 23 for the operational control of heating apparatus system 01. Temperature monitoring assembly 24 controls operation of the heating apparatus system according to the temperature of the house thermostat, the temperature of the magnetron assembly 11 and the temperature of the solid substrate members 21. The temperature monitoring assembly 24 prevents overheating of all system components including magnetron assembly 11. Insulation 25 is attached to partition wall 04 and the outer surface of inner hull 19 to prevent unwanted heat transfer and provide additional thermal insulation between heat magnetron chamber 02 and heat exchange chamber 03 to improve heat exchange efficiency to the heated air and reliability of the system. Compartment doors 22 comprising the lateral side panels of inner hull 19 and outer hull 20 provide access to the heat exchange department 03 and the solid substrate members 21.

The embodiment of the invention successfully accomplishes the enhancement of the heating efficiency over conventional, combustion based heating systems.

### BACKGROUND OF THE INVENTION

1. Field of the Invention

The present invention relates to air heating systems using microwaves as a source of energy generated by a magnetron, and particularly using a solid substrate which couples with microwaves to heat the air. Furthermore, the present invention provides heated air for space heating while reducing the operating cost over a conventional heating apparatus.

The heating system is generally referred as to a heating system for heating a space in order of the heating of the indoor air and the convection of the heated air. The type of a heating apparatus can be classified by a heat source. In other words, current heating apparatus use the heat energy generated according to the combustion of fuel or the application of a power source to the electric coil or the nichrome wire.

Even though a relatively superior heating apparatus for the firing of fuel, for example gas or petroleum, is used to heat a room, the fact is that complete combustion has not yet been realized in spite of their research and development. Thus, when the fuel is burnt in the heating apparatus, the incomplete combustion causes smoke pollution. In order to reduce the smoke pollution, a heating apparatus tends to be complex and is made relatively large, following that it is not economical in light of its manufacturing cost.

Further, a conventional heating apparatus could not avoid generation of soot or poisonous gas harmful to the human body, if it is used for a long period. It has had the inconvenience and problems that the indoor air must be exchanged with the fresh air to prevent a loss of life during its use in the closed space.

Moreover, the cost of fossil fuels for a conventional heating apparatus is becoming increasingly more expensive. Fossil fuels used for a conventional heating apparatus are finite resources, and the concern over their depletion is resulting in rising prices of fuels. Therefore, a conventional heating apparatus using the combustion of fossil fuels is becoming less economical to operate.

Also, a conventional heating apparatus using the power source is provided with an electric coil, such as nichrome wire is ineffective in heating the air in large spaces. The heating time required is substantially longer than forced air heating through convection because the initial heating is weak and/or the heating is not uniformly distributed.

2. Prior Art

Heating Systems using microwaves produced by a magnetron are known. The Naraseiki

Patent, U.S. Pat. No. 6,080,976 demonstrates a system for a heating element for heating a fluid passing there through using the energy generated by coupling with microwaves. An air blower is provided to heat air through convection with the heating element. The heating element is mainly made of carbon powder, alumina powder, and silicon carbide powder. This system does not teach a method for heating air with only a solid substrate. A method for heating air for space heating is also not taught. A solid substrate comprising mainly silicon carbide and concrete is not taught.

The Samsung Electronics patent, U.S. Pat. No. 5,111,012 demonstrates a system for heating air using microwaves. The system described uses three chambers. The system does not teach using two concentric chambers. The system also does not identify a specific substrate which heats well by coupling with microwaves.

The Monteleone patent, U.S. Pat. No. 6,858,824 demonstrates a system which uses energy generated by coupling with microwaves to heat a conductive, fluid medium to provide domestic hot water and heat for a building. Monteleone describes a system which uses direct heating of a conductive medium, which circulates through the system, but a method for using a solid substrate, which is fixed in the furnace is not taught.

The Moreti patent, U.S. Pat. No. 4,310,738 teaches a heating furnace to heat a fluid. The use of an insulated chamber with a circuitous flow path and a magnetron are taught. A system for heating air is not taught. A system using a solid substrate, which is fixed in the furnace is not taught.

The Brown patent, U.S. Pat. No. 3,891,817, teaches a system for heating a building using microwave heat. The Brown patent teaches the direct heating of a fluid and not the use of a solid substrate alone.

Utilizing microwave energy to heat air is an efficient and economical method of providing heated air for space heating a building. A system which uses a solid substrate to couple with microwaves and exchange heat to the air through convection is inexpensive to operate and requires little maintenance. The use of a solid substrate which couples effectively with microwaves increases the efficiency of the system and reduces space heating costs.

### Objects

Accordingly, the objects of the invention are as follows:

1. To provide a heating system for heating air using microwaves produced by a magnetron, which heat a solid substrate to change the temperature of air.

2. To provide a heating system using microwaves produced by a magnetron that is efficient, reliable, and inexpensive.

### BRIEF DESCRIPTION OF THE FIGURES

The invention will be described below in detail with reference to the accompanying drawings.

FIG. 1 is a cross-sectional view showing the embodiment of an electronic microwave heating apparatus according to the principle of the invention;

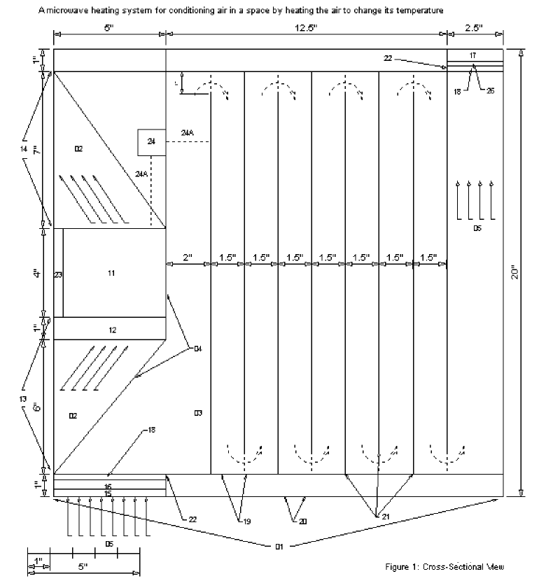

FIG. 1A is a enlarged cross-sectional view showing the microwave transmitting plate and the dispersing fan mounted adjacent to the magnetron, the microwave guiding means, and the heat exchanging chamber according to the principle of the invention;

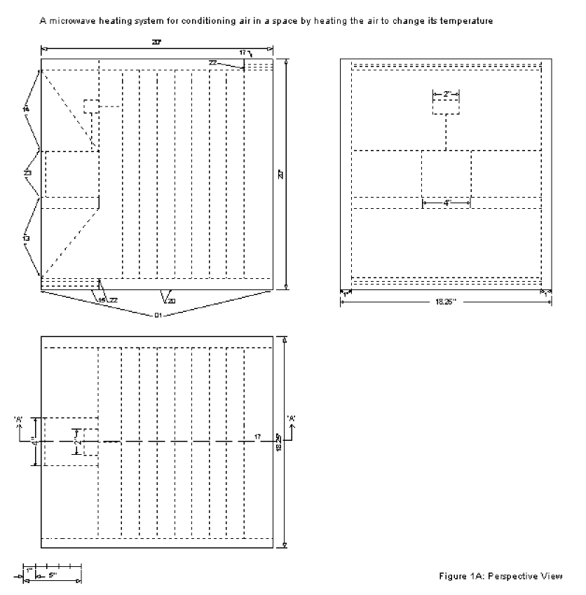

FIG. 2 is a perspective view showing the configuration of the microwave absorbing solid substrate member according to the principle of the invention.

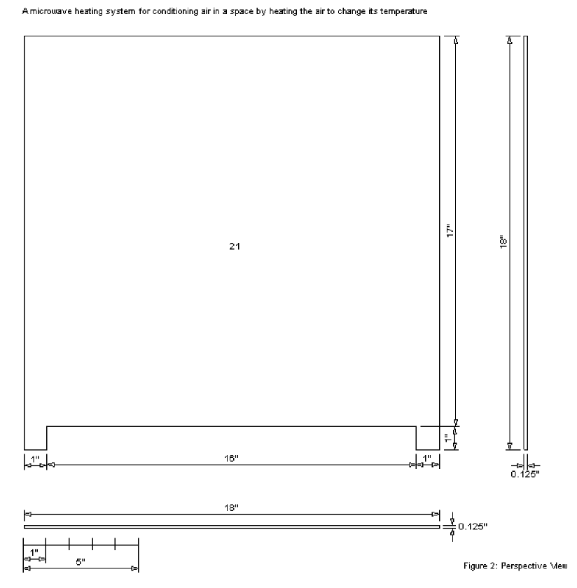

### DESCRIPTION OF THE NUMERALS FOR THE FIGURES

### NUMERAL DESCRIPTION

01 Heating Apparatus System
02 Magnetron Chamber
03 Heat Exchange Chamber
04 Partition Wall
05 Heated Air Flow
11 Magnetron Assembly
12 Cooling Fan
13 Cooling Fan Intake
14 Cooling Fan Exhaust
15 Blowing Fan
16 Heated Air Intake Channel
17 Heated Air Return Channel
18 Microwave Shielding
19 Inner Hull
20 Outer Hull
21 Solid Substrate Members
22 Compartment Door
23 Power Distribution Assembly
24 Temperature Monitoring Assembly
24A Temperature Monitoring Wires
25 Insulation
26 Muffling Filter

What is claimed is:

1. A system for heating air using microwaves comprising:
a heater including:
an inner enclosure forming an enclosure and having an upper end and a lower end,
an outer enclosure forming an enclosure and having an upper end and a lower end,
a solid heating substrate mounted inside the inner enclosure,
one magnetron mounted inside the outer enclosure for directing microwaves into the solid heating substrate,
an electrical distribution system connected to the magnetron,
an air intake channel in air communication with the heated space and the interior of the inner enclosure,
a return channel in air communication with the interior of the inner enclosure and the heated space,
an air circulation fan for moving air from the heated space into the intake channel, from the intake channel into the inner enclosure, from the inner enclosure into the return channel, and from the return channel into the heated space, wherein the circulation fan is located in the return channel,
an insulation located outside of the outer enclosure,
an insulation located within the outer enclosure and outside of the inner enclosure and about the magnetron,
a temperature monitoring system for detecting the temperature inside the heater, wherein a temperature sensor in electrical communication with the temperature monitoring system is located in close proximity to the magnetron and a temperature sensor in electrical communication with the temperature monitoring system is located in close proximity to the substrate inside the inner enclosure,
and a microwave leak detector located in the interior of the enclosure in close proximity to the intake channel for detecting the presence of microwaves.

2. A system for heating air according to claim 1, wherein the solid substrate is composed in part of silicon carbide.

3. A system for heating air according to claim 1, wherein the solid substrate is composed mainly of silicon, carbon, silicon carbide, concrete, or aluminum.
